(19) United States
(12) Patent Application Publication
(10) Pub. No.: US 2018/0163837 A1
(43) Pub. Date: Jun. 14, 2018

(54) LOCK-UP DEVICE FOR TORQUE CONVERTER

(71) Applicant: EXEDY Corporation, Neyagawa-shi, Osaka (JP)

(72) Inventor: Keiji SATO, Neyagawa-shi, Osaka (JP)

(21) Appl. No.: 15/576,753

(22) PCT Filed: Jul. 20, 2016
(86) PCT No.: PCT/JP2016/071238

§ 371 Date: Nov. 24, 2017

(30) Foreign Application Priority Data
Aug. 19, 2015 (JP) 2015-161941
Mar. 23, 2016 (JP) 2016-059035

(51) Int. Cl. F16H 45/02; F16H 41/24; F16H 61/14

(52) U.S. Cl. CPC F16H 45/02; F16H 41/24; F16H 2041/246; F16H 2045/0273; F16H 61/14

(57) ABSTRACT

A lock-up device for a torque converter includes a clutch part, a piston, a lock-up oil chamber, a cancellation oil chamber and a cancellation hydraulic pressure maintenance circuit. The clutch part is disposed in a power transmission path between a front cover and a transmission-side member. The piston is provided to be movable in an axial direction. The lock-up oil chamber is supplied with hydraulic oil for moving the piston to turn the clutch part into a power transmission activated state. The cancellation oil chamber is provided on the opposite side of the lock-up oil chamber through the piston, and is supplied with the hydraulic oil. The cancellation hydraulic pressure maintenance circuit is provided in an oil passage for leading the hydraulic oil discharged from the cancellation oil chamber to the transmission side, and maintains the cancellation oil chamber at a predetermined hydraulic pressure.

### CROSS-REFERENCES TO RELATED APPLICATIONS

This application is the U.S. National Phase of PCT International Application No. PCT/JP2016/071238, filed on Jul. 20, 2016. That application claims priority to Japanese Patent Application No. 2015-161941, filed on Aug. 19, 2015, and Japanese Patent Application No. 2016-059035, filed on Mar. 23, 2016. The contents of all three applications are herein incorporated by reference in their entirety.

### BACKGROUND

### Technical Field

The present disclosure relates to a lock-up device, and particularly to a lock-up device for a torque converter, which transmits a torque from a front cover to a transmission-side member.

### Background Art

Torque converters are often equipped with a lock-up device that directly transmits a torque from a front cover to a turbine. The lock-up device includes a clutch part disposed between the front cover and the turbine and a piston that is axially movable. Additionally, moving the piston by hydraulic pressure enables the clutch part to be turned into a power transmission activated state (a clutch-on state=a lock-up on state) and a power transmission deactivated state (a clutch-off state=a lock-up off state).

In a lock-up device described in Japan Laid-open Patent Application Publication No. 2013-145025, a lock-up oil chamber is provided between the front cover and the piston so as to actuate the piston. Additionally, a cancellation oil chamber is provided on the opposite side of the lock-up oil chamber through the piston so as to cancel internal pressure and hydraulic pressure attributed to centrifugal force. Supplying hydraulic oil to the cancellation oil chamber inhibits fluctuations in engaging force of a lock-up clutch that is attributed to fluctuations in internal pressure of the torque converter, and also, cancels centrifugal hydraulic pressure acting on the piston in the clutch-off state.

### BRIEF SUMMARY

In the device of Japan Laid-open Patent Application Publication No. 2013-145025, the cancellation oil chamber includes a communication hole with a small diameter in the outer peripheral part thereof. Additionally, the cancellation oil chamber is configured to be supplied with the hydraulic oil through the communication hole. In general, the cancellation oil chamber is required to be supplied with a small amount of hydraulic oil. Hence, the communication hole has a small diameter as described in Japan Laid-open Patent Application Publication No. 2013-145025.

However, the communication hole with a small diameter is likely to be clogged with a foreign object and/or so forth. The cancellation oil chamber is drained through the inner or outer peripheral part of an input shaft of a transmission and so forth. Hence, when the communication hole is clogged, the cancellation oil chamber inevitably runs out of the hydraulic oil and a desired hydraulic pressure cannot be obtained therein. Additionally, when the desired hydraulic pressure cannot be obtained in the cancellation oil chamber, cancellation of the internal pressure and that of the centrifugal hydraulic pressure are disabled.

It is an object of the present disclosure to enable a lock-up device including a cancellation oil chamber to stably maintain hydraulic pressure in the cancellation oil chamber at a desired pressure.

### Solution to Problems

(1) A lock-up device for a torque converter according to a first aspect of the present disclosure is a device for transmitting a torque inputted to a front cover to a transmission-side member, and includes a clutch part, a piston, a lock-up oil chamber, a cancellation oil chamber and a cancellation hydraulic pressure maintenance circuit. The clutch part is disposed in a power transmission path between the front cover and the transmission-side member. The piston is provided to be movable in an axial direction. The lock-up oil chamber is supplied with a hydraulic oil for moving the piston to turn the clutch part into a power transmission activated state. The cancellation oil chamber is provided on an opposite side of the lock-up oil chamber through the piston, and is supplied with the hydraulic oil. The cancellation hydraulic pressure maintenance circuit is provided in an oil passage leading the hydraulic oil discharged from the cancellation oil chamber to the transmission side, and maintains the cancellation oil chamber at a predetermined hydraulic pressure.

Here, the lock-up oil chamber is supplied with the hydraulic oil and the piston is actuated, whereby the clutch part is turned into the power transmission activated state. Additionally, the cancellation oil chamber is provided on the opposite side of the lock-up oil chamber through the piston, and is supplied with the hydraulic oil. It should be noted that the hydraulic pressure in the cancellation oil chamber is lower than that in the lock-up oil chamber. When the cancellation oil chamber is supplied with the hydraulic oil, fluctuations in engaging force of the lock-up clutch are inhibited that are attributed to fluctuations in internal pressure of the torque converter, and in a lock-up off state, the piston is prevented from moving in a direction to turn the clutch part into a lock-up on state by centrifugal hydraulic pressure.

The cancellation oil chamber is supplied with the hydraulic oil through a hole with a small diameter, a gap or so forth. Even when such a hole or gap is clogged with a foreign object and/or so forth, the cancellation oil chamber is maintained at a desired hydraulic pressure by the cancellation hydraulic pressure maintenance circuit. Therefore, the function of the cancellation oil chamber can be stabilized.

A lock-up device for a torque converter according to a second aspect of the present disclosure relates to the device according to the first aspect, and further includes a first seal member provided on an outer peripheral part of the cancellation oil chamber and a second seal member provided on an inner peripheral part of the cancellation oil chamber. Additionally, the cancellation oil chamber is supplied with the hydraulic oil through a gap on the first seal member.

A lock-up device for a torque converter according to a third aspect of the present disclosure relates to the device according to the first or second aspect, and further includes a support boss having an annular shape and an oil chamber plate having a disc shape. The support boss protrudes in the axial direction so as to be fixed to an inner peripheral part of the front cover, and supports the piston on an outer peripheral surface thereof such that the piston is slidable in the axial direction. The oil chamber plate is fixed to the outer peripheral surface of the support boss so as to interpose the piston together with the front cover therebetween, and forms the lock-up oil chamber together with the piston therebetween.

A lock-up device for a torque converter according to a fourth aspect of the present disclosure relates to the device according to the third aspect, wherein the cancellation oil chamber is disposed between the front cover and the piston, and the support boss includes an oil passage communicated with the lock-up oil chamber and an oil passage communicated with the cancellation oil chamber.

A lock-up device for a torque converter according to a fifth aspect of the present disclosure relates to the device according to any of the first to fourth aspects, wherein the cancellation hydraulic pressure maintenance circuit includes a restrictor provided in an oil passage leading the hydraulic oil discharged from the cancellation oil chamber to the transmission side.

A lock-up device for a torque converter according to sixth aspect of the present invention relates to the device according to the fifth aspect, wherein the cancellation hydraulic pressure maintenance circuit includes an upper oil passage located above a rotational axis of the torque converter, the upper oil passage being provided in part of the oil passage leading the hydraulic oil discharged from the cancellation oil chamber to the transmission side.

According to the present disclosure described above, a lock-up device including a cancellation oil chamber is enabled to stably maintain the hydraulic pressure in the cancellation oil chamber at a desired pressure.

### BRIEF DESCRIPTION OF THE DRAWINGS

FIG. 1 is a cross-sectional configuration diagram of a torque converter including a lock-up device according to an exemplary embodiment of the present disclosure.

FIG. 2 is a diagram showing part extracted from FIG. 1.

FIG. 3 is a partial front view of an engaging part between a pressure plate and a cover plate.

FIG. 4 is a partial front view of an engaging part between a piston and the cover plate.

FIG. 5 is an enlarged view of part extracted from FIG. 1.

FIG. 6 is an external perspective view of an engaging structure between the piston and the cover plate.

FIG. 7 is a cross-sectional configuration diagram for explaining a damper mechanism.

FIG. 8 is a diagram according to another exemplary embodiment of the present disclosure and corresponds to FIG. 1.

### DETAILED DESCRIPTION OF EMBODIMENTS

[Entire Configuration of Torque Converter]

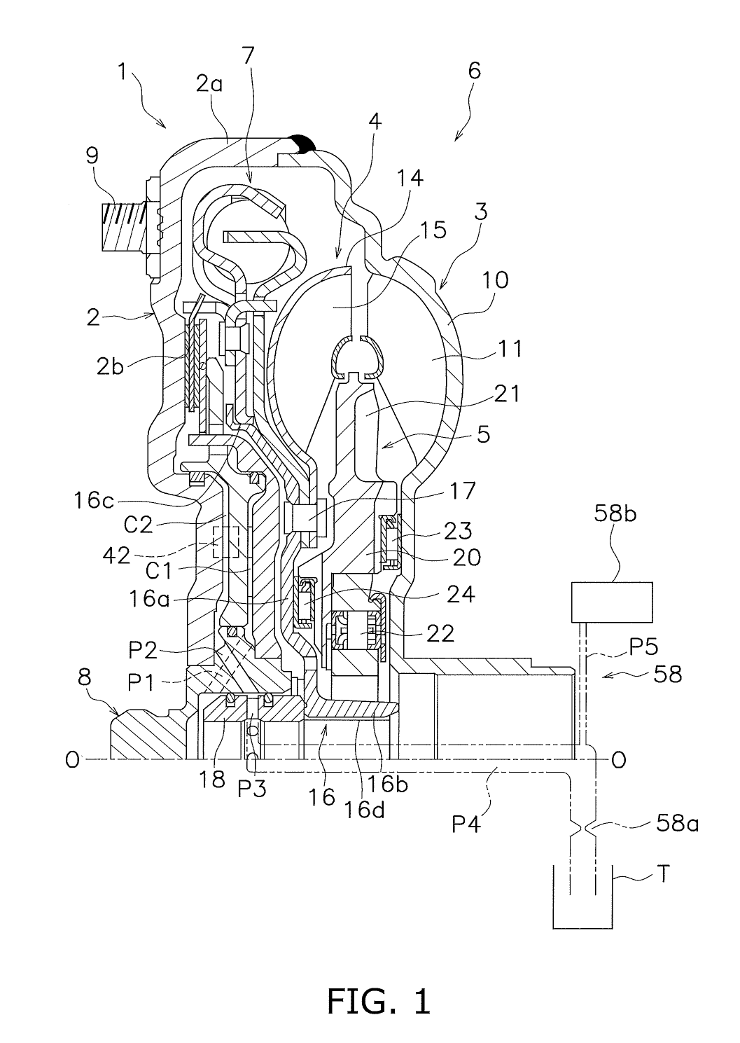

FIG. 1 is a vertical cross-sectional view of a torque converter 1 employing an exemplary embodiment of the present disclosure. The torque converter 1 is a device that transmits a torque from a crankshaft of an engine to an input shaft of a transmission. In FIG. 1, the engine (not shown in the drawing) is disposed on the left side, whereas the transmission (not shown in the drawing) is disposed on the right side. Line O-O depicted in FIG. 1 is a rotational axis of the torque converter 1.

The torque converter 1 mainly includes a front cover 2, a torque converter body 6 composed of three types of bladed wheels (an impeller 3, a turbine 4 and a stator 5) and a lock-up device 7.

[Front Cover 2]

The front cover 2 is a disc-shaped member and a center boss 8 is fixed to the inner peripheral end of the front cover 2 by welding. The center boss 8 is a columnar member extending axially toward the engine, and is inserted into a center hole of the crankshaft (not shown in the drawings).

It should be noted that the front cover 2 is configured to be coupled to the crankshaft of the engine through a flexible plate, although the configuration is not shown in the drawings. In other words, a plurality of bolts 9 are fixed to the engine-side lateral surface of the outer peripheral part of the front cover 2, while being aligned at equal intervals in the circumferential direction. The outer peripheral part of the flexible plate is fixed to the front cover 2 by nuts screwed onto the bolts 9.

The front cover 2 includes an outer peripheral side tubular part 2a in the outer peripheral part thereof. The outer peripheral side tubular part 2a extends axially toward the transmission. The impeller 3 is fixed to the distal end of the outer peripheral side tubular part 2a by welding. As a result, a fluid chamber, the interior of which is filled with hydraulic oil, is formed by the front cover 2 and the impeller 3.

Additionally, the front cover 2 includes a flat part 2b having an annular shape on the turbine 4—side lateral surface of the radially intermediate part thereof. The flat part 2b is shaped to protrude toward the turbine than parts located on the inner and outer peripheral sides thereof. The surface of the flat part 2b functions as a friction surface (the flat part 2b will be hereinafter referred to as “friction surface 2b”).

[Impeller 3]

The impeller 3 is mainly composed of an impeller shell 10 and a plurality of impeller blades 11 fixed to the inside of the impeller shell 10. Additionally, the outer peripheral side distal end of the impeller shell 10 is welded to the front cover 2 as described above. It should be noted that the impeller shell 10 includes a tubular part in the inner peripheral end thereof. The tubular part extends toward the transmission.

[Turbine 4]

The turbine 4 is disposed in axial opposition to the impeller 3 within the fluid chamber. The turbine 4 is mainly composed of a turbine shell 14, a plurality of turbine blades 15 fixed to the inside of the turbine shell 14, and a turbine hub 16 fixed to the inner peripheral end of the turbine shell 14. The turbine shell 14 and the turbine hub 16 are fixed by a plurality of rivets 17.

The turbine hub 16 includes a flange part 16a, a tubular part 16b and a damper support part 16c. The flange part 16a is a disc-shaped part to which the inner peripheral end of the turbine shell 14 is fixed. The tubular part 16b is shaped to extend from the inner peripheral part of the flange part 16a toward the transmission. The tubular part 16b includes a spline hole 16d in the inner peripheral part thereof, and the spline hole 16d is capable of being meshed with a spline shaft provided on the tip of the input shaft of the transmission (not shown in the drawings). The damper support part 16c is formed by extending the outer peripheral part of the flange part 16a. The damper support part 16c will be described below in detail.

A collar 18 is fixed to the inner peripheral end of the turbine hub 16 on the opposite side (the engine side) of the tubular part 16b. On the inner peripheral end of the turbine hub 16, the collar 18 extends toward the engine from approximately the same radial position as the tubular part 16b.

[Stator 5]

The stator 5 is a mechanism disposed between the inner peripheral part of the impeller 3 and that of the turbine 4 so as to regulate the flow of hydraulic oil returning from the turbine 4 to the impeller 3. The stator 5 is made by integral casting of resin, aluminum alloy or so forth. The stator 5 mainly includes a stator shell 20 having a disc shape and a plurality of stator blades 21 integrated with the stator shell 20 on the outer peripheral side of the stator shell 20. The stator shell 20 is coupled to a stationary shaft (not shown in the drawings) through a one-way clutch 22.

A thrust bearing 23 is disposed between the stator shell 20 and the impeller shell 10, whereas a thrust bearing 24 is disposed between the stator shell 20 and the flange part 16a of the turbine hub 16.

[Lock-up Device 7]

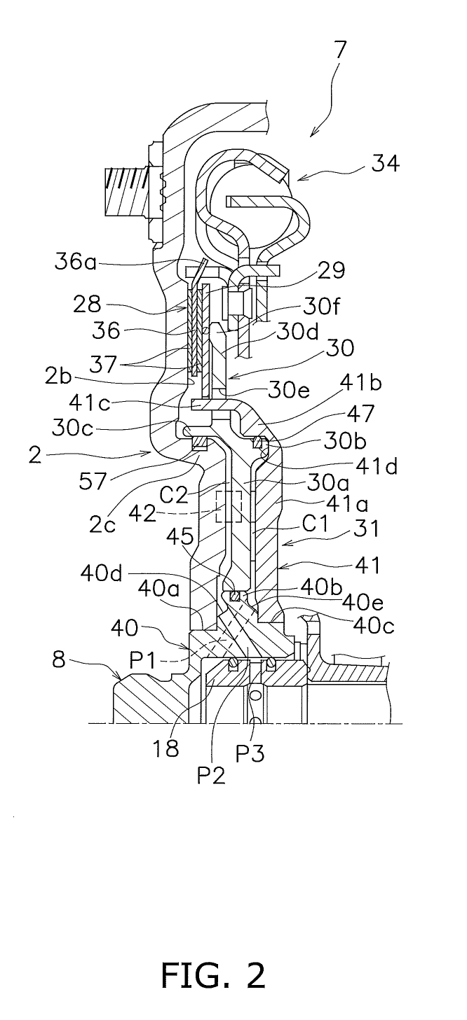

The lock-up device 7 is a device disposed between the front cover 2 and the turbine 4 so as to directly transmit power from the front cover 2 to the turbine 4. As shown close-up in FIG. 2, the lock-up device 7 includes a clutch disc 28, a pressure plate 29, a piston 30, a piston actuation mechanism 31 and a damper mechanism 34.

<Clutch Disc 28>

The clutch disc 28 has an annular shape and is capable of being pressed in contact with the friction surface 2b of the front cover 2. The clutch disc 28 includes a core plate 36 having an annular shape and friction members 37 that have an annular shape and are fixed to both lateral surfaces of the core plate 36. The core plate 36 has an outer peripheral part larger than the outer diameter of each friction member 37, and is bent at a predetermined angle toward the turbine at a part thereof protruding to the outer peripheral side beyond the friction members 37. Additionally, the bent part includes a plurality of engaging protrusions 36a.

<Pressure Plate 29>

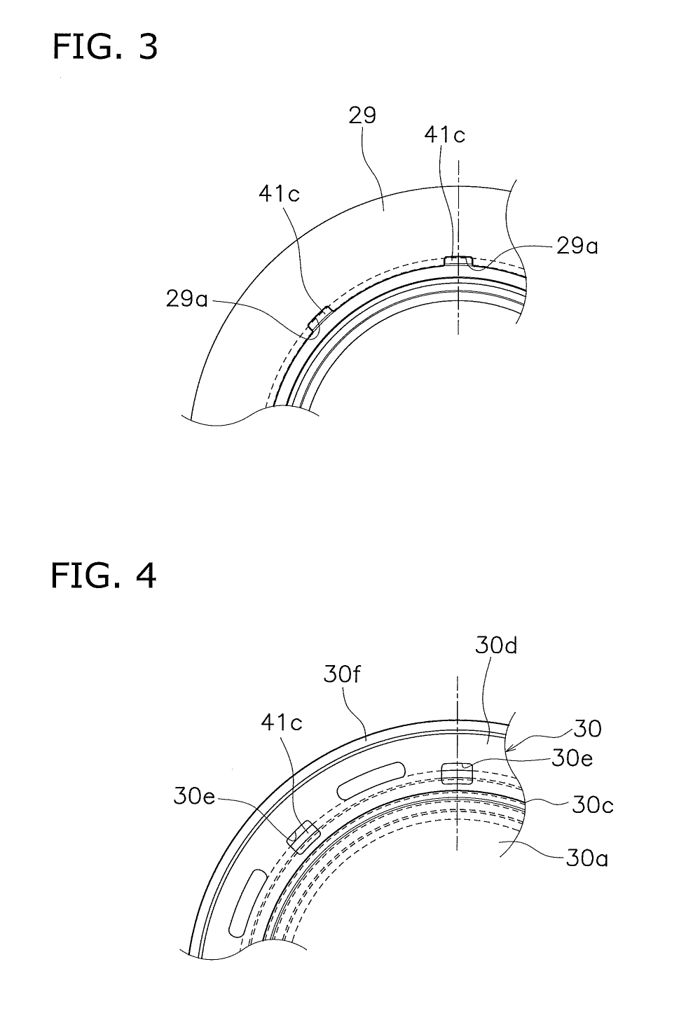

The pressure plate 29 is disposed between the clutch disc 28 and the piston 30 so as to be movable in the axial direction. The pressure plate 29 is pressed by the piston 30, and thereby presses the clutch disc 28 toward the front cover 2. Additionally, the pressure plate 29 has an annular shape, and the outer diameter thereof is larger than that of each friction member 37 of the clutch disc 28, while the inner diameter thereof is smaller than that of each friction member 37. As shown close-up in FIG. 3, the pressure plate 29 includes a plurality of grooves 29a on the inner peripheral end thereof. The grooves 29a are aligned at predetermined intervals in the circumferential direction. Each groove 29a has a predetermined depth in the radial direction and is opened to the inner peripheral side. It should be noted that FIG. 3 is a view of the pressure plate 29 as seen from the front cover 2 side.

<Piston 30>

As shown in FIGS. 1 and 2, the piston 30 is disposed between the front cover 2 and the turbine 4 and is movable in the axial direction. The piston 30 includes a pressure receiving part 30a having a disc shape, a first protruding part 30b, a second protruding part 30c and an outer peripheral disc part 30d. It should be noted that the body thereof is composed of the pressure receiving part 30a and the outer peripheral disc part 30d.

The pressure receiving part 30a is a part that receives the pressure of hydraulic oil, and the first protruding part 30b is included in the outer peripheral part of the pressure receiving part 30a so as to protrude toward the turbine 4. The outer peripheral end of the pressure receiving part 30a slantingly extends toward the front cover 2, and the second protruding part 30c is included in the distal end of this slantingly extending part so as to further protrude therefrom toward the front cover 2.

The outer peripheral disc part 30d is integrated with the pressure receiving part 30a, and is shifted (off-set) to the front cover side with respect to the pressure receiving part 30a. As shown in FIG. 4, the outer peripheral disc part 30d includes a plurality of openings 30e in the inner peripheral part thereof. The openings 30e are aligned at predetermined intervals in the circumferential direction. The plural openings 30e axially penetrate therethrough. It should be noted that FIG. 4 is a view of the piston 30 as seen from the front cover 2 side.

Additionally, the outer peripheral disc part 30d includes a pressure applying part 30f having an annular shape in the outer peripheral end thereof. The pressure applying part 30f is included in the outer peripheral end of the outer peripheral disc part 30d so as to protrude toward the front cover 2. The pressure applying part 30f is shaped to make contact with the approximately middle of the radial width of the pressure plate 29.

<Piston Actuation Mechanism 31>

The piston 30 is axially actuated by the piston actuation mechanism 31. As shown in FIG. 2, the piston actuation mechanism 31 includes a support boss 40, a cover plate 41 (an oil chamber plate) and a return mechanism 42.

—Support Boss 40—

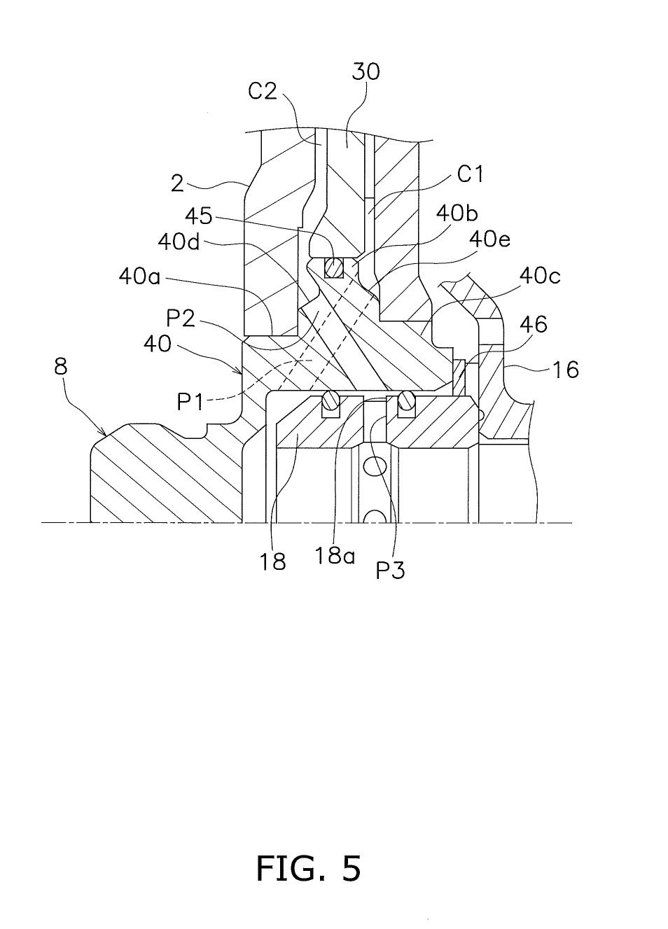

As shown in FIGS. 2 and 5, the support boss 40 is fixed to the inner peripheral part of the front cover 2. Specifically, the support boss 40 is part of the center boss 8, and is made in the shape of a tube axially extending from the turbine 4—side end of the center boss 8. The support boss 40 includes a first fixation part 40a, a piston support part 40b, a second fixation part 40c, a first intermediate part 40d and a second intermediate part 40e. It should be noted that FIG. 5 is a partial enlarged view of FIG. 1.

The inner peripheral end surface of the front cover 2 is fixed to the outer peripheral surface of the first fixation part 40a by welding. In other words, the inner peripheral end surface of the front cover 2 is inserted and fixed onto the outer peripheral surface of the first fixation part 40a, whereby the front cover 2 is axis-aligned with respect to the center boss 8 and the support boss 40.

The piston support part 40b has an outer diameter larger than that of the first fixation part 40a. The inner peripheral end surface of the piston 30 is supported by the outer peripheral surface of the piston support part 40b so as to be axially slidable thereon. Additionally, a seal member 45 is attached to the outer peripheral surface of the piston support part 40b. The seal member 45 seals between the outer peripheral surface of the piston support part 40b and the inner peripheral end surface of the piston 30. It should be noted that the front cover 2—side lateral surface of the piston support part 40b tilts to gradually approach to the front cover 2 to the outer peripheral side.

The second fixation part 40c has an outer diameter smaller than that of the piston support part 40b. In other words, the piston support part 40b and the second fixation part 40c compose a step. The inner peripheral end surface of the cover plate 41 is fixed to the outer peripheral surface of the second fixation part 40c by welding. Even when the cover plate 41 is welded to the second fixation part 40c, welding-related strain of the piston support part 40b can be inhibited by setting the outer diameter of the second fixation part 40c to be smaller than that of the piston support part 40b to which the seal member 45 is attached. Therefore, sealing performance between the piston support part 40b and the piston 30 is enhanced.

The first intermediate part 40d is provided between the first fixation part 40a and the piston support part 40b. The outer peripheral surface of the first intermediate part 40d tilts such that the diameter thereof gradually increases from the front cover 2 side to the turbine 4 side. The minimum diameter of the outer peripheral surface of the first intermediate part 40d is larger than the diameter of the first fixation part 40a, while the maximum diameter thereof is smaller than the diameter of the piston support part 40b.

The second intermediate part 40e is provided between the piston support part 40b and the second fixation part 40c. The outer peripheral surface of the second intermediate part 40e tilts such that the diameter thereof gradually reduces from the front cover 2 side to the turbine 4 side. The maximum diameter of the outer peripheral surface of the second intermediate part 40e is smaller than the diameter of the piston support part 40b, while the minimum diameter thereof is larger than the diameter of the second fixation part 40c.

It should be noted that a thrust washer 46 is disposed between the turbine 4—side end surface of the support boss 40 and the turbine hub 16. The thrust washer 46 includes at least one radial groove on a surface thereof.

—Cover Plate 41—

The cover plate 41 is disposed such that the pressure receiving part 30a of the piston 30 is interposed between the cover plate 41 and the front cover 2. As shown in FIG. 2, the cover plate 41 includes a body 41a, a seal part 41b and a torque transmission part 41c.

The body 41a has a disc shape, and as described above, the inner peripheral end surface thereof is fixed to the outer peripheral surface of the second fixation part 40c of the support boss 40 by welding.

The seal part 41b is included in the outer peripheral part of the body 41a, and includes a recess 41d dented therefrom toward the turbine 4. The first protruding part 30b of the piston 30 is inserted into the recess 41d. A seal member 47 is attached to the outer peripheral part of the first protruding part 30b, and the outer peripheral part thereof makes contact with the inner peripheral surface of the recess 41d. Therefore, a lock-up oil chamber C1 is formed between the piston 30 and the cover plate 41 by the seal member 47.

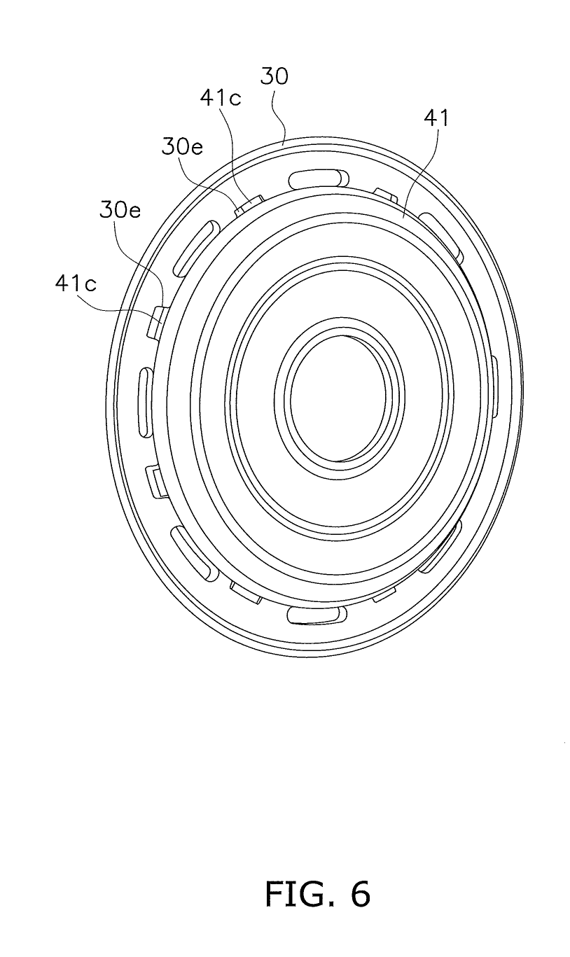

The torque transmission part 41c is provided on the further outer peripheral side of the seal part 41b. The torque transmission part 41c is composed of a plurality of engaging protrusions (hereinafter referred to as “engaging protrusions 41c”) extending from the outer peripheral part of the seal part 41b to the front cover side. As shown in FIGS. 2 and 4, the engaging protrusions 41c penetrate the openings 30e provided in the piston 30, and are engaged with the grooves 29a provided on the inner peripheral end of the pressure plate 29. FIG. 6 shows a perspective view of the cover plate 41 and the piston 30 as seen from the turbine 4 side.

With the configuration described above, a torque transmitted to the cover plate 41 can be transmitted to the pressure plate 29. Additionally, rotation of the piston 30 relative to the cover plate 41 can be restricted by appropriately setting the circumferential dimension of each of the engaging protrusions 41c as the torque transmission part and the circumferential dimension of each of the openings 30e of the piston 30.

The return mechanism 42 is a mechanism disposed between the front cover 2 and the piston 30 so as to urge the piston 30 in a direction separating from the friction surface of the front cover 2. Additionally, the return mechanism 42 has a function of adjusting the gap between the friction surface 2b of the front cover 2 and the pressure applying part 30f of the piston 30 as well as the function of urging the piston 30 in the direction separating from the front cover 2.

Specifically, when the atmosphere temperature is low, the piston 30 is moved to separate from the front cover 2. Therefore, the gap between the piston 30 and the front cover 2, in other words, the gap of the part that the clutch disc 28 is provided (the release allowance of the clutch disc 28) is increased. Consequently, a drag torque can be inhibited low in the part inclusive of the clutch disc 28.

On the other hand, when the atmosphere temperature becomes high, and for instance, becomes a room temperature, the piston 30 is moved to approach to the front cover 2. Therefore, the gap between the piston 30 and the front cover 2, in other words, the gap of the part that the clutch disc 28 is provided (the release allowance of the clutch disc 28) is reduced. Consequently, a lock-up on state can be quickly made.

<Hydraulic Circuit>

With the configuration of the piston actuation mechanism 31, as shown in FIG. 2, the lock-up oil chamber C1 is formed between the pressure receiving part 30a of the piston 30 and the body 41a of the cover plate 41. Additionally, the front cover 2 includes a step part 2c, having an axially extending tubular shape, between the radially intermediate part thereof and the inner peripheral part thereof. A seal member 57 is attached to the outer peripheral surface of the step part 2c. The seal member 57 makes contact with the inner peripheral surface of the second protruding part 30c of the piston 30. Therefore, a cancellation oil chamber C2 is formed between the pressure receiving part 30a of the piston 30 and the front cover 2 so as to cancel the hydraulic pressure to be generated in the lock-up oil chamber C1 when a lock-up off state is made.

It should be noted that the seal member 57, attached to the step part 2c of the front cover 2, exerts sealing performance inferior to that of a normal seal member (e.g., the seal member 47 attached to the first protruding part 30b). Specifically, even when the seal member 57 is attached to the step part 2c, the gap of the part that the seal member 57 is abutted to the object thereof is set to be wider than a normally set gap. Therefore, a larger amount of hydraulic oil leaks in the part that the seal member 57 is attached than in the other sealed parts. Accordingly, the cancellation oil chamber C2 is supplied with the hydraulic oil, whereby the cancellation oil chamber C2 is set at a desired pressure.

As shown in FIGS. 2 and 5, the support boss 40 includes a first oil passage P1 and a second oil passage P2, both of which radially penetrate therethrough. The first oil passage P1 is opened in the slope of the second intermediate part 40e of the support boss 40, and the lock-up oil chamber C1 and the space of the inner peripheral part of the support boss 40 are communicated therethrough. The second oil passage P2 is opened in the slope of the first intermediate part 40d, and the cancellation oil chamber C2 and the space of the inner peripheral part of the support boss 40 are communicated therethrough. The collar 18 includes a groove 18a having an annular shape, and the groove 18a includes a plurality of third oil passages P3 radially penetrating therethrough. Additionally, the second oil passage P2 is communicated with the third oil passages P3.

Additionally, as shown in FIG. 1, the third oil passages P3 are communicated with a fourth oil passage P4 penetrating the interior of the input shaft (not shown in the drawing) of the transmission. The fourth oil passage P4 is communicated with a drain tank T of the transmission. A hydraulic pressure maintenance circuit 58 (a cancellation hydraulic pressure maintenance circuit) is provided in an intermediate part of the fourth oil passage P4 so as to maintain the internal pressure of the cancellation oil chamber C2 at a predetermined pressure.

The hydraulic pressure maintenance circuit 58 includes a restrictor 58a and a hydraulic pressure supply source 58b. The restrictor 58a is provided in an outlet part of the fourth oil passage P4, and the hydraulic pressure supply source 58b is connected to the fourth oil passage P4 through a communication oil passage P5. The restrictor 58a may be an orifice, which is formed by narrowing the diameter of part of the fourth oil passage P4, or so forth as long as it is configured to apply resistance to the flow of hydraulic oil. The hydraulic pressure supply source 58b includes a hydraulic pump, a pressure control valve and so forth, and is configured to maintain the oil passages P2, P3 and P4 and the cancellation oil chamber C2 at a predetermined pressure.

<Damper Mechanism 34>

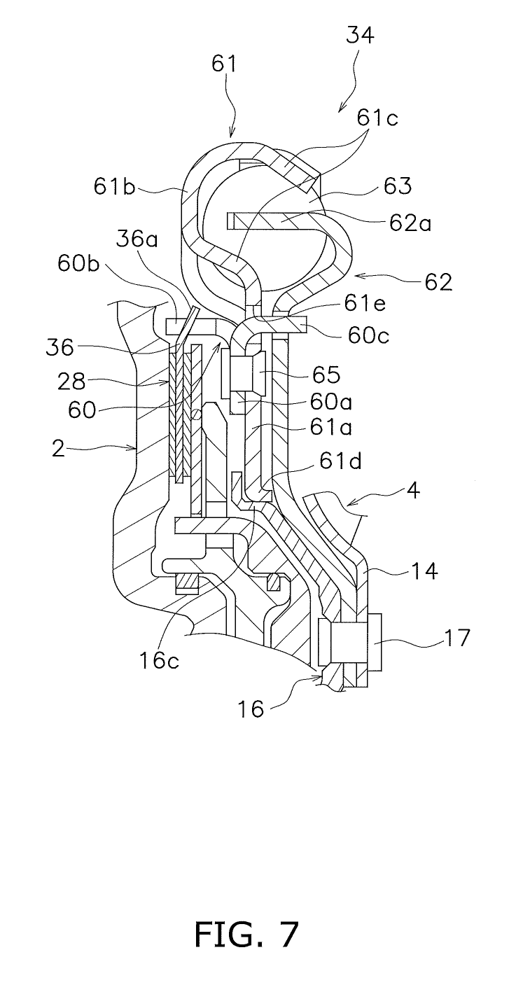

The damper mechanism 34 is a mechanism disposed between the clutch disc 28 and the turbine 4 so as to transmit a torque from the clutch disc 28 to the turbine 4. As shown in FIG. 7, the damper mechanism 34 includes an engaging member 60, a drive plate 61, a driven plate 62 and a plurality of torsion springs 63.

The engaging member 60 includes a fixed part 60a, a plurality of first engaging parts 60b and a plurality of second engaging parts 60c. The fixed part 60a has an annular shape and is fixed to the drive plate 61 by rivets 65. The plural first engaging parts 60b are formed by bending the outer peripheral end of the fixed part 60a toward the front cover 2, and are meshed with the engaging protrusions 36a provided on the outer periphery of the core plate 36 of the clutch disc 28. The clutch disc 28 is axially movable with respect to the first engaging parts 60b, but is prevented from rotating relatively thereto. The plural second engaging parts 60c are formed by bending the outer peripheral end of the fixed part 60a toward the turbine 4.

The drive plate 61 has an annular shape, and is disposed between the piston 30 and the turbine 4. The drive plate 61 transmits a torque, transmitted to the engaging member 60, to the torsion springs 63. The drive plate 61 includes a disc part 61a, a plurality of support parts 61b and a plurality of engaging parts 61c.

The inner peripheral end surface of the disc part 61a is bent toward the turbine 4, and is provided as a positioning part 61d. The positioning part 61d is supported by the damper support part 16c provided on the outer peripheral end of the turbine hub 16, and is positioned in the radial direction and the axial direction. The disc part 61a includes holes 61e axially penetrating the outer peripheral part thereof. The second engaging parts 60c of the engaging member 60 extend toward the turbine 4 while penetrating the holes 61e.

The support parts 61b are included in the outer peripheral part of the disc part 61a and have a C-shaped cross-section. The plural torsion springs 63 are accommodated in the support parts 61b, and are restricted from moving in the radial direction and from moving toward the front cover 2 by the support parts 61b.

The engaging parts 61c are included in the outer peripheral part of the disc part 61a, and each is provided between adjacent two of the support parts 61b. The engaging parts 61c are partially engaged with both end surfaces of the torsion springs 63 accommodated in the support parts 61b.

The driven plate 62 has a roughly disc shape, and is disposed between the drive plate 61 and the turbine 4. The driven plate 62 is a member that transmits a torque, transmitted to the torsion springs 63, to the turbine hub 16. The driven plate 62 is fixed at the inner peripheral end thereof to the turbine shell 14 and the turbine hub 16 by the rivets 17. Additionally, the driven plate 62 extends to the outer peripheral side along the lateral surface of the turbine shell 14. Engaging parts 62, included in the outer peripheral part of the drive plate 62, are engaged with both end surfaces of the torsion springs 63.

[Actions]

For lock-up releasing (a clutch-off state=the lock-up off state) in the lock-up device 7, the lock-up oil chamber C1 is connected to a drain. Therefore, the hydraulic oil inside the lock-up oil chamber C1 is returned to the tank T side through the first oil passage P1. In this condition, the piston 30 is moved toward the turbine 4 by the return mechanism 42, and a pressing force applied to the pressure plate 29 from the pressure applying part 30f of the piston 30 is released. Therefore, the lock-up off state (a power transmission deactivated state) is made, and the torque from the front cover 2 is transmitted from the impeller 3 to the turbine 4 through the hydraulic oil, and is transmitted to the input shaft of the transmission through the turbine hub 16.

It should be noted that when the lock-up off state is made, chances are that a centrifugal force acts on the hydraulic oil remaining in the lock-up oil chamber C1 whereby the piston 30 is pressed toward the front cover 2. When the piston 30 is moved toward the front cover 2, the drag torque due to the clutch disc 28 is increased.

To cope with this, in the present device, as described above, the amount of leakage through the seal member 57 is set to be larger than that through a normal seal member. With this setting, the hydraulic oil leaking through the seal member 57 intrudes into the cancellation oil chamber C2, whereby the piston 30 is inhibited from moving toward the front cover 2. In other words, the pressing force acting on the piston 30 due to the centrifugal force acting on the hydraulic oil in the lock-up oil chamber C1 is configured to be canceled by the hydraulic oil leaking through the seal member 57 into the cancellation oil chamber C2. The hydraulic pressure in the cancellation oil chamber C2 is maintained at a predetermined pressure by the hydraulic oil intruding thereinto through the seal member 47, and also, by the working of the hydraulic pressure maintenance circuit 58.

It should be noted that when the gap on the seal member 57 is clogged with a foreign object and/or so forth, the hydraulic oil no longer intrudes into the cancellation oil chamber C2 through the seal member 57. However, even in such a case, the hydraulic pressures in the second to fourth oil passages P2, P3 and P4 and the cancellation oil chamber C2 are maintained at a predetermined pressure.

On the other hand, when the lock-up on state (the clutch-on state=a power transmission activated state) is made in the lock-up device 7, the hydraulic oil is supplied to the lock-up oil chamber C1. In other words, the hydraulic oil is supplied to the end surface of the collar 18, and simultaneously, the hydraulic oil is supplied to the lock-up oil chamber C1 through the first oil passage P1. The piston 30 is thereby moved toward the front cover 2, and moves the pressure plate 29 toward the front cover 2.

Accordingly, the clutch disc 28 is interposed and held between the front cover 2 and the pressure plate 29, and the lock-up on state is made.

When the lock-up on state is made, the torque from the front cover 2 is transmitted to the damper mechanism 34 through a path of “the support boss 40 the cover plate 41 the pressure plate 29 the clutch disc 28”, and is also transmitted from the front cover 2 to the damper mechanism 34 through the clutch disc 28.

Additionally, similarly in the lock-up on state, the hydraulic coil intrudes into the cancellation oil chamber C2 through the seal member 57. Therefore, as described above, the hydraulic pressure in the cancellation oil chamber C2 becomes a predetermined pressure, whereby fluctuations in engaging force of the lock-up clutch can be inhibited that are attributed to fluctuations in internal pressure of the torque converter body 6.

It should be noted that even when the seal member 57 is clogged with a foreign object and/or so forth, similarly to the above, the hydraulic pressure in the cancellation oil chamber C2 can be maintained at a predetermined pressure by the hydraulic pressure maintenance circuit 58.

In the damper mechanism 34, the torque inputted to the engaging member 60 is transmitted to the turbine 4 through the torsion springs 63 and the driven plate 62, and is further transmitted to the input shaft of the transmission through the turbine hub 16.

[Other Exemplary Embodiments]

The present disclosure is not limited to the exemplary embodiment described above, and a variety of changes or modifications can be made without departing from the scope of the present disclosure.

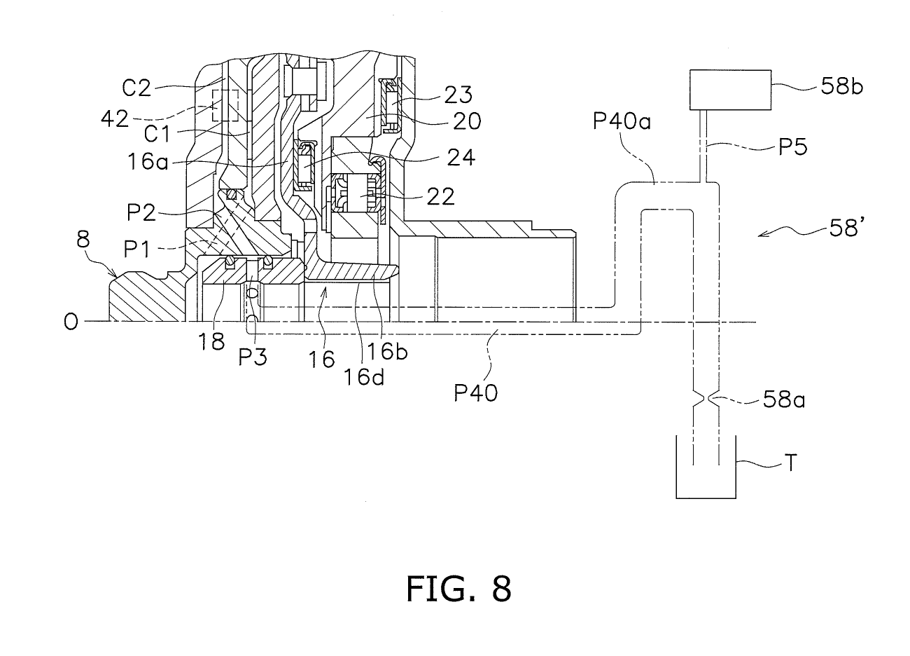

(a) FIG. 8 shows a hydraulic pressure maintenance circuit 58′ according to another exemplary embodiment. A fourth oil passage P40 is herein provided instead of the fourth oil passage P4 of the aforementioned exemplary embodiment. The fourth oil passage P40 is communicated with the third oil passage P3, and is provided in the interior of the input shaft (not shown in the drawing) of the transmission. The fourth oil passage P40 is communicated with the drain tank T of the transmission, and includes an upper oil passage P40a in part thereof. The upper oil passage P40a is disposed to be located above the rotational axis O-O of the torque converter 1.

It should be noted that the other constituent elements of the hydraulic pressure maintenance circuit 58′ are similar to those of the aforementioned exemplary embodiment. In other words, the hydraulic pressure maintenance circuit 58′ includes the restrictor 58a and the hydraulic pressure supply source 58b. The restrictor 58a is provided in the outlet part of the fourth oil passage P40, and the hydraulic pressure supply source 58b is connected to the fourth oil passage P40 through the communication oil passage P5. The restrictor 58a may be an orifice, which is formed by narrowing the diameter of part of the fourth oil passage P40, or so forth as long as it is configured to apply resistance to the flow of hydraulic oil. The hydraulic pressure supply source 58b includes a hydraulic pump, a pressure control valve and so forth, and is configured to maintain the oil passages P2, P3 and P40 and the cancellation oil chamber C2 at a predetermined pressure.

Advantageous effects obtained in the aforementioned exemplary embodiment can be similarly obtained in the exemplary embodiment herein described.

(b) Layouts of the lock-up oil chamber and the cancellation oil chamber and those of the oil passages communicated with these oil chambers are not limited to those in the aforementioned exemplary embodiment. The layouts in the aforementioned exemplary embodiment may be reversed in the axial direction.

### INDUSTRIAL APPLICABILITY

According to the present disclosure, a lock-up device including a cancellation oil chamber is enabled to stably maintain the hydraulic pressure in the cancellation oil chamber at a desired pressure.

### REFERENCE SIGNS LIST

2 Front cover

2b Friction surface

28 Clutch disc

30 Piston

40 Support boss

51 Cover plate (oil chamber plate)

58, 58′ Hydraulic pressure maintenance circuit

58a Restrictor

C1 Lock-up oil chamber

C2 Cancellation oil chamber

P1 First oil passage

P2 Second oil passage

P3 Third oil passage

P4, P40 Fourth oil passage

P40a Upper oil passage

1. A lock-up device for a torque converter, the lock-up device for transmitting a torque inputted to a front cover to a transmission-side member, the lock-up device comprising:
a clutch part disposed in a power transmission path between the front cover and the transmission-side member;
a piston provided to be movable in an axial direction;
a lock-up oil chamber supplied with a hydraulic oil for moving the piston to turn the clutch part into a power transmission activated state;
a cancellation oil chamber provided on an opposite side of the lock-up oil chamber through the piston, the cancellation oil chamber supplied with the hydraulic oil; and
a cancellation hydraulic pressure maintenance circuit provided in an oil passage for leading the hydraulic oil discharged from the cancellation oil chamber to the transmission side, the cancellation hydraulic pressure maintenance circuit for maintaining the cancellation oil chamber at a predetermined hydraulic pressure.

2. The lock-up device for a torque converter according to claim 1, further comprising:
a first seal member provided on an outer peripheral part of the cancellation oil chamber; and
a second seal member provided on an inner peripheral part of the cancellation oil chamber, wherein
the cancellation oil chamber is supplied with the hydraulic oil through a gap on the first seal member.

3. The lock-up device for a torque converter according to claim 1, further comprising:
a support boss having an annular shape, the support boss protruding in the axial direction so as to be fixed to an inner peripheral part of the front cover, the support boss supporting the piston on an outer peripheral surface thereof such that the piston is slidable in the axial direction; and
an oil chamber plate having a disc shape, the oil chamber plate fixed to the outer peripheral surface of the support boss so as to interpose the piston together with the front cover therebetween, the oil chamber plate forming the lock-up oil chamber together with the piston therebetween.

4. The lock-up device for a torque converter according to claim 3, wherein
the cancellation oil chamber is disposed between the front cover and the piston, and
the support boss includes an oil passage communicated with the lock-up oil chamber and an oil passage communicated with the cancellation oil chamber.

5. The lock-up device for a torque converter according to claim 1, wherein the cancellation hydraulic pressure maintenance circuit includes a restrictor provided in an oil passage for leading the hydraulic oil discharged from the cancellation oil chamber to the transmission side.

6. The lock-up device for a torque converter according to claim 5, wherein the cancellation hydraulic pressure maintenance circuit includes an upper oil passage located above a rotational axis of the torque converter, the upper oil passage provided in part of the oil passage for leading the hydraulic oil discharged from the cancellation oil chamber to the transmission side.
